(19) United States
(12) Patent Application Publication
(10) Pub. No.: US 2003/0157988 A1
(43) Pub. Date: Aug. 21, 2003

(54) Fiber reinforced plastic propeller shaft

(76) Inventors: Yasunori Nonogaki, Kariya-shi (JP); Koya Suzuki, Kariya-shi (JP)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/365,188

(22) Filed: Feb. 12, 2003

(30) Foreign Application Priority Data
Feb. 20, 2002 (JP) 2002-043213

(51) Int. Cl. F16C 3/00

(52) U.S. Cl. 464/181

(57) ABSTRACT

A fiber reinforced plastic propeller shaft has a fiber reinforced plastic pipe, and at least one metal member attached to an end of the pipe. The metal member is provided with a serration having a plurality of teeth having an apex angle. When the metal member is attached to the end of the pipe, each tooth forms on the inner surface of the pipe end a groove extending along the axial direction of the pipe. The apex angle of each tooth is between 45° and 75°.

### BACKGROUND OF THE INVENTION

The present invention relates to a fiber reinforced plastic propeller shaft that includes a fiber reinforced plastic pipe and metal members attached to the ends of the pipe, each metal member having serration including a number of teeth that form grooves extending in the axial direction in the inner surface of the ends of the pipe.

A propeller shaft for transmitting power generated by the engine of an automobile to driven wheels typically includes a metal shaft and yokes welded to the ends of the shaft. The yokes form part of metal universal joints. The universal joints are coupled to a drive shaft and a driven shaft, respectively. This type of propeller shaft is referred to as a metal propeller shaft.

In recent years, there is a great demand for lighter parts of vehicles to reduce the weight of vehicles. Accordingly, propeller shafts made of fiber-reinforced plastic (FRP) are used to reduce the weight. FIG. 5(a) shows such a fiber reinforced plastic (FRP) propeller shaft 51, which is disclosed, for example, in Japanese Laid-Open Patent Publication No. 2000-120649. The propeller shaft 51 has an FRP pipe 52 and metal yokes 53 press fitted to the ends of the pipe 52. The yokes 53 couple the pipe 52 to a drive shaft and driven shaft (neither is shown).

Each yoke 53 has a serration 54 formed on a part of the outer surface that contacts the FRP pipe 52. The outer diameter of the serration 54 is greater than the inner diameter of the FRP pipe 52. Press fitting the contacting part of the yoke 53 into the FRP pipe 52 causes the teeth of the serration 54 of the yoke 53 to form grooves on the inner surface of the FRP pipe 52. The engagement of the serration 54 and the FRP pipe 52 ensures a sufficient coupling strength to permit the yoke 53 and the FRP pipe 52 to rotate integrally.

The apex angle θ of each tooth 54a of the serration 54 is approximately 90°. As shown in FIG. 5(b), the apex angle θ refers to an angle defined by lines Ls representing the sides of the tooth 54a. A greater apex angle θ requires a greater force to press fit the serration 54 into the FRP pipe 52. This requires facilities of a greater press force and may break the pipe 52. The cost is increased accordingly. Further, since it is difficult to point the end of the tooth 54a, the end of the tooth 54a is formed to have a trapezoidal or arcuate cross-section. Therefore, an apex angle of approximately 90° is likely to cause the teeth 54a to expand the FRP pipe 52 when the serration 54 is press fitted. In this case, the teeth 54a cannot form grooves having a sufficient depth, and the engagement of the teeth 54a with the inner surface of the FRP pipe 52 is not sufficient. As a result, the coupling strength of the FRP pipe 52 and the yokes 53 is not satisfactory.

The engagement portions of the yokes coupled to an FRP pipe must transmit a required torque (torsional torque) and prevent the FRP pipe from receiving excessive force when the yokes are press fitted to the pipe. Therefore, the press fitting force needs to be minimized. However, the torque transmitting capability from the yokes to the FRP pipe does not depend only on the engagement amount of the teeth 54a with the FRP pipe 52, but also on the reactive force, or fastening force, produced when the serration 54 is press fitted to the pipe 52 and expands the pipe 52. Thus, if the apex angle θ is too small, the pipe 52 will not be sufficiently expanded and there will be no sufficient fastening force. As a result, a sufficient torque transmitting capability will not be obtained. Also, if the apex angle θ is too small, a required strength will not be obtained.

In recent car designs, a technology to make a propeller shaft to collapse or break in the axial direction for gradually absorbing the great impact of a collision has been proposed. This technology prevents an excessive impact in a collision and thus creates a sufficient time for various safety devices such as air bags to operate. In one of the designs according to the technology, the yokes are pressed further into an FRP pipe than the original positions by the impact force of a collision when the impact force exceeds a predetermined value. This axially collapses or breaks the propeller shaft. In this configuration also, the yokes are preferably press fitted to the FRP pipe with a relatively small force during manufacture.

### SUMMARY OF THE INVENTION

Accordingly, it is an objective of the present invention to provide an FRP propeller shaft that permits serrations to be easily press fitted to an FRP pipe and sufficient torsional torque to be transmitted between the FRP pipe and the serrations.

To achieve the foregoing and other objectives and in accordance with the purpose of the present invention, a fiber reinforced plastic propeller shaft is provided. The shaft has a fiber reinforced plastic pipe, and a metal member attached to at least one end of the pipe. The metal member is provided with a serration having a plurality of teeth having an apex angle. When the metal member is attached to the end of the pipe, each tooth forms on the inner surface of the pipe end a groove extending along the axial direction of the pipe. The apex angle of each tooth is between 45° and 75°.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a partial cross-sectional view illustrating an FRP propeller shaft according to one embodiment of the present invention;

FIG. 2 is a partly cross-sectional view illustrating the yoke of FIG. 1;

FIG. 3(a) is an enlarged partial front view of the serration of the yoke shown in FIG. 2;

FIG. 3(b) is an enlarged partial cross-sectional view showing the engaging portion of the serration and the FRP pipe;

FIG. 4 is an enlarged partial front view showing a serration according to another embodiment;

FIG. 5(a) is a cross-sectional view showing a prior art FRP propeller shaft; and

FIG. 5(b) is a schematic view showing the apex angle of a tooth of the serration shown in FIG. 5(a).

### DETAILED DESCRIPTION OF THE PREFERRED EMBODIMENTS

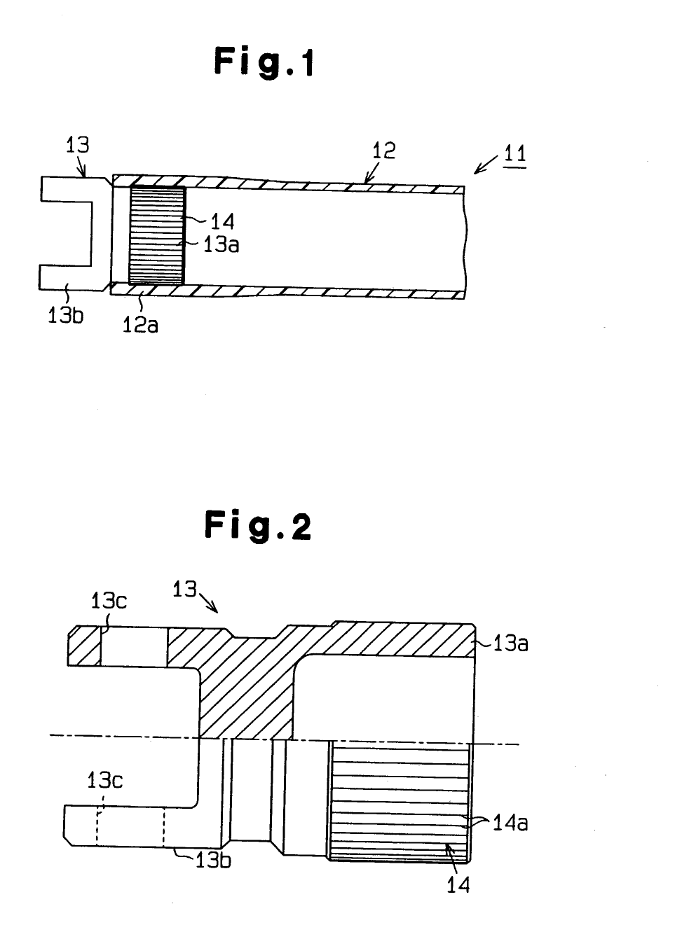

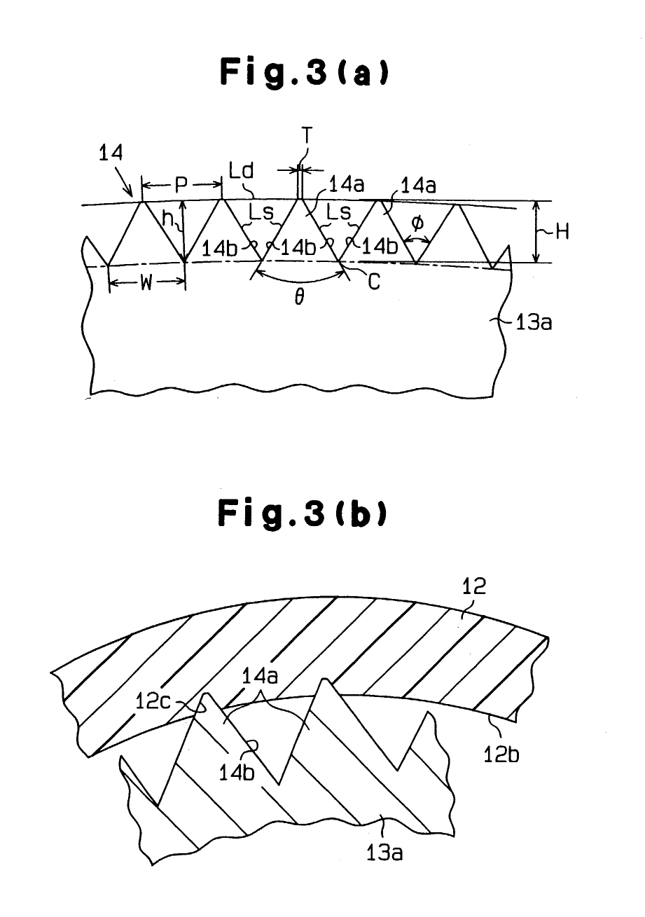

One embodiment according to the present invention will now be described with reference to FIGS. 1 to 3. FIG. 1 is a cross-sectional view showing an FRP propeller shaft 11. FIG. 2 is a side view of a yoke 13 with a half cut away. FIG. 3(a) is an enlarged partial front view showing a serration 14. FIG. 3(b) is an enlarged partial cross-sectional view showing the engaging portions 13a of the serration 14 and an FRP pipe 12.

As shown in FIG. 1, the FRP propeller shaft 11 includes the FRP pipe 12 and a pair of metal members, which are the metal yokes 13 in this embodiment. Each yoke 13 is press fitted into one end of the pipe 12. Each yoke 13 includes an engaging portion 13a and a joint portion 13b. The engaging portion 13a is press fitted in the corresponding end of the FRP pipe 12. The joint portion 13b is coupled to a universal joint (for example, a cross joint), which is used to couple the propeller shaft 11 with the drive shaft of the vehicle. A hole 13c is formed in the joint portion 13b (see FIG. 2). The universal joint is engaged with the hole 13c. The engaging portion 13a of each yoke 13 is press fitted to an engaging portion 12a located at each end of the FRP pipe 12. The yokes 13 are thus coupled to the FRP pipe 12.

The engaging portions 12a of the FRP pipe 12 are thicker than the remainder of the pipe 12. The FRP pipe 12 is manufactured through the filament winding method (FW method). The reinforcing fibers of the pipe 12 are carbon fibers. The matrix resin is epoxy resin. Fibers are impregnated with resin and are wound about a mandrel. Then, the resin is hardened with heat. Thereafter, the mandrel is removed to form the FRP pipe 12.

The serration 14 having axially extending teeth 14a is formed on the outer surface of each engaging portion 13a. The teeth 14a form axially extending grooves 12c (see FIG. 3(b)) on the end inner surface 12b of the FRP pipe 12. As shown in FIG. 3(a), the teeth 14a are formed at a predetermined pitch P along the circumferential direction. Each tooth 14a has a triangular cross-section.

The apex angle θ of each tooth 14a is 60°. The connecting angle φ defined by any adjacent pair of the teeth 14a is substantially equal to the apex angle θ. Specifically, the difference between the apex angle θ and the connecting angle φ is from 0° to 5°. In this embodiment, the cross-section of the teeth 14a form a saw-tooth pattern.

The outer diameter of each serration 14 is between 70 mm and 75 mm (in this embodiment, 71 mm). A predetermined number of teeth, which is between 142 and 145 (i.e., 142, 143, 144, or 145), are formed on the serration 14. In this embodiment, the number of the teeth is 144. The sides of each tooth 14a are represented by lines Ls in FIG. 3(a). The distance H between the intersection of lines Ls of adjacent teeth 14a and the outer circumferential diameter line Ld of the serration 14 is between 0.9 mm and 1.8 mm. In this embodiment, the distance H is 1.25 mm. In this embodiment, the tooth height h is equal to the distance H.

The distal tooth thickness T of the teeth 14a is equal to or less than 0.1 mm and the width W of the proximal end of the teeth 14a is 1.5 mm. In this embodiment, the distal tooth thickness T is 0.05 mm. The radial dimension of the portion of each tooth 14a that engages with, or digs into, the FRP pipe 12 is equal to or less than one fifth of the tooth height h. In this embodiment, the radial dimension of the digging portion is 0.15 mm. For purposes of illustration, the digging portions are exaggerated in FIG. 3(b).

The serration 14 of each yoke 13 is formed, for example, with a topping hob. Unlike a normal hob, the topping hob can machine the distal section of the teeth 14a to make the distal end narrow.

The operations of the yoke 13, which is constructed as above, will hereafter be described. When coupling the yokes 13 with the FRP pipe 12, the FRP pipe 12 is fixed with a jig. The pipe 12 and the yoke 13 are aligned and the serration 14 is press fitted in the pipe 12 with a tool. When the serration 14 is press fitted, the teeth 14a enter the pipe 12 while forming the grooves 12c on the inner surface of the pipe 12. The teeth 14a are firmly engaged with the grooves 12c, which engages the yoke 13 with the pipe 12 at a high strength. When the yokes 13 are attached to the ends of the FRP pipe 12, the manufacture of the propeller shaft 11 is completed.

If the apex angle θ of the serration teeth 14a is approximately 90° as in the prior art, a great force is required to press fit the serration 14 into the FRP pipe 12. However, in the above embodiment, the apex angle θ is 60° and the connecting angle φ (defined by the sides 14b of each adjacent pair of the teeth 14a) is substantially equal to the apex angle θ. This configuration reduces the force required for press fitting and guarantees the torsional torque transmitting capability between the FRP pipe 12 and the yokes 13.

The torsional torque transmitting capability of the FRP pipe 12 and the press fitting force were examined by using the yokes 13 of varied apex angles θ and varied tooth height h of the serration 14. The examination revealed that in the range of the apex angle θ between 45° and 75°, the press fitting force and the torsional torque transmitting capability are satisfactory. If the apex angle θ is less than 45°, the strength of the teeth 14a is not sufficient. If the apex angle θ is greater than 75°, a relatively great press fitting force is required.

The apex angle θ should be between 45° and 75°, preferably between 50° and 70°, more preferably between 55° and 65°.

When the apex angle θ is 45°, and the tooth height is 1.7 mm, the width W of the tooth distal end is slightly less than that in a case where the apex angle θ is 60°. When the apex angle θ is 75°, and the tooth height is 0.95 mm, the width W of the tooth distal end is slightly greater than that in a case where the apex angle θ is 60°.

This embodiment provides the following advantages.

(1) The propeller shaft 11 includes the FRP pipe 12 and the metal yokes 13 attached to the ends of the pipe 12. Each yoke 13 has the serration 14 with the teeth 14a. The teeth 14a form the axially extending grooves 12c in the corresponding end of the pipe 12. The apex angle θ of the teeth 14a is between 45° and 75°. Therefore, a force required when press fitting the serration 14 of each yoke 13 to an end of the FRP pipe 12 is reduced. Also, the torsional torque transmitting capability of the pipe 12 is improved.

(2) The apex angle θ of each tooth 14a in the serration 14 is between 45° and 75°. The connecting angle φ (defined by an adjacent pair of the teeth 14a) is substantially equal to the apex angle θ. Therefore, a force required when press fitting the serration 14 of each yoke 13 to an end of the FRP pipe 12 is reduced. Also, the torsional torque transmitting capability of the pipe 12 is improved.

(3) The radial dimension of the portion of each tooth 14a that digs into the FRP pipe 12 is equal to or less than one fifth of the tooth height h. Therefore, when press fitting the serration 14 of the yoke 13 into the FRP pipe 12, the FRP pipe 12 does not receive excessive expanding force.

(4) The outer diameter of the serration 14 is between 70 mm and 75 mm, and the number of the teeth 14a is between 142 and 145. Thus, when pressing fitting the serration 14, the FRP pipe 12 does not receive excessive expanding force.

(5) The serration 14 is formed such that the distance H between the intersection of adjacent lines Ls representing the sides 14b of the teeth 14a and the outer diameter line Ld of the serration 14 is between 0.9 mm and 1.8 mm. This configuration facilitates the machining of the serration 14.

(6) The serration 14 is formed such that the distal tooth thickness T of the teeth 14a is equal to or less than 0.1 mm (In this embodiment, the distal tooth thickness T is 0.05 mm). This configuration requires less press fitting force and makes the digging amount appropriate.

(7) The serration 14 is formed such that the distal tooth thickness T of the teeth 14a is equal to or less than 0.1 mm and the width W of the proximal end of the teeth 14a is 1.5 mm. In this embodiment, the distal tooth thickness T is 0.05 mm. Therefore, a force required when press fitting the serration 14 of each yoke 13 to an end of the FRP pipe 12 is reduced. Also, the torsional torque transmitting capability of the pipe 12 is improved.

It should be apparent to those skilled in the art that the present invention may be embodied in many other specific forms without departing from the spirit or scope of the invention. Particularly, it should be understood that the invention may be embodied in the following forms.

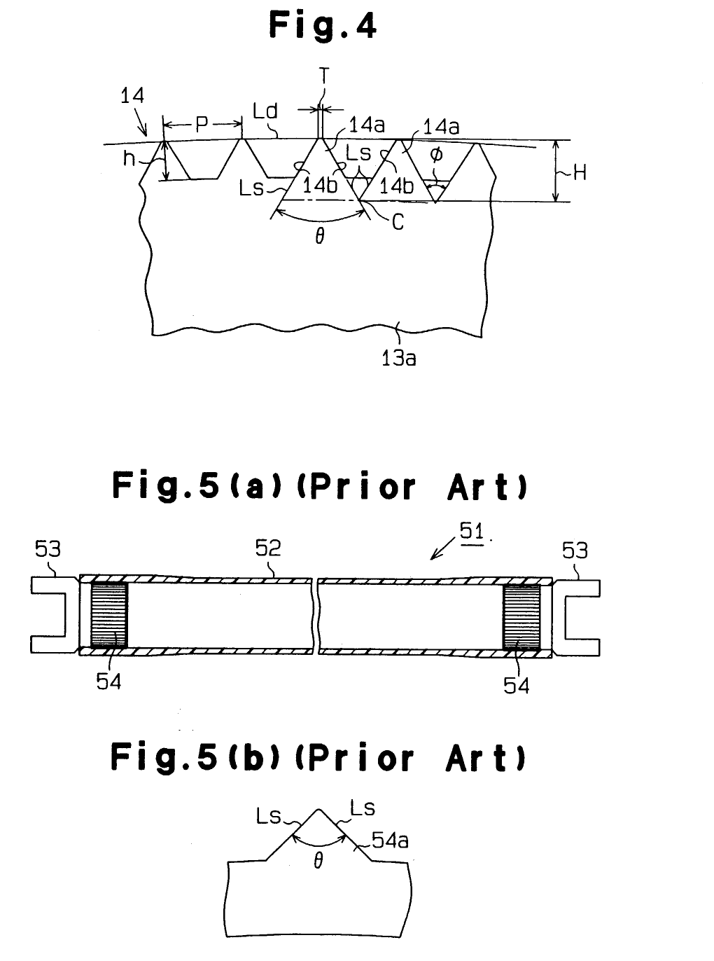

The proximal ends of an adjacent pair of the teeth 14a need not be continuous. As shown in FIG. 4, the proximal ends may be separated by a predetermined distance. The connecting angle φ defined by the sides 14b of the adjacent pair of the teeth 14a is substantially the same as the apex angle θ. This modification has the same advantages as the case where the teeth 14a have a saw-tooth cross-section.

The sides 14b of each tooth 14a need not be linear as represented by lines Ls. Lines representing the sides 14b may be curved at the proximal end of the tooth 14a. In other words, the facing sides 14b of each adjacent pair of the teeth 14a are connected through a curved plane. In this case, the apex angle θ refers to the angle defined by the linear sections of lines Ls.

The sides 14b of the teeth 14a represented by lines Ls need not be linear. The entire sides 14b may be, for example, involute. If the ratio (h/W) of the tooth height h and the proximal width W is between 0.63 and 1.16, and the distal width is 0.05±0.02 mm, the force required for press fitting the serrations 14 to the ends of the pipe 12 is reduced, and the torsional torque transmitting capability is improved. If the sides 14b of each tooth 14a is flat and the ratio (h/W) is 1.16, the apex angle of each tooth 14a is approximately 45°. If the sides 14b of each tooth 14a are flat and the ratio (h/W) is 0.63, the apex angle is approximately 75°.

In FIG. 4, sections of the sides 14b of each tooth 14a at the proximal end may be arcuate. In other words,. the sides 14b of each tooth 14a are curved in the vicinity of the proximal end. The connecting angle φ need not be substantially the same as the apex angle θ.

In the illustrated embodiment, the yoke 13 includes the integrated engaging portion 13a and joint portion 13b. The serration 14 is formed on the engaging portion 13a. However, the engaging portion 13a and the joint portion 13b may be separately formed. The joint portion 13b may be welded or friction welded to the engaging portion 13a on which the serration 14 is machined. In this case, if a component used for conventional propeller shaft may be used as the joint portions 13b, the manufacturing cost is reduced.

In the modification where the yoke 13 is formed by welding the joint portion 13b to the engaging portion 13a, the joint portion 13b may be welded to the engaging portion 13a after the engaging portion 13a is press fitted in the FRP pipe 12.

The radial dimension of the part of each tooth 14a that digs into the pipe 12 may be greater than one fifth of the tooth height. If the apex angle θ is approximately 45°, an amount of the digging portion that is greater than one fifth of the tooth height does not excessively increase the press fitting resistance and guarantees a sufficient torsional torque transmitting capability.

In the illustrated embodiment, the serration 14 is formed by machining a metal pipe on which the joint portion 13b is formed. However, the serration 14 may be formed through cold or hot forging.

Instead of the yokes 13, metal shafts on which serration is formed may be press fitted in the FRP pipe 12. In this case, the metal shafts function as the metal members.

The FRP pipe 12 need not be entirely cylindrical. However, the FRP pipe 12 may be a polygonal prism with the ends of circular cross-section.

The FRP pipe 12 may be manufactured through a method other than the filament winding method. For example, the FRP pipe 12 may be formed through sheet winding method. As long as the FRP pipe 12 has the required characteristics as a propeller shaft, the pipe 12 may be manufactured through any method. However, it is preferable that the pipe 12 be manufactured through filament winding.

The reinforcing fibers and the matrix resin of the FRP pipe 12 need not be carbon fibers and epoxy resin. For example, other types of fibers that have high elasticity and high strength such as aramide fiber and glass fiber may be used as the reinforcing fibers. Thermosetting resin such as unsaturated polyester, phenol resin, and polyimide resin may be used as the matrix resin.

The matrix resin of the FRP need not be thermosetting. For example, an ultraviolet curing resin or a thermoplastic resin may be used as the matrix resin.

Therefore, the present examples and embodiments are to be considered as illustrative and not restrictive and the invention is not to be limited to the details given herein, but may be modified within the scope and equivalence of the appended claims.

1. A fiber reinforced plastic propeller shaft comprising:
a fiber reinforced plastic pipe; and
a metal member attached to at least one end of the pipe, wherein the metal member is provided with a serration having a plurality of teeth having an apex angle, wherein, when the metal member is attached to the end of the pipe, each tooth forms on the inner surface of the pipe end a groove extending along the axial direction of the pipe, and wherein the apex angle of each tooth is between 45° and 75°.

2. The fiber reinforced plastic propeller shaft according to claim 1, wherein a connecting angle defined by facing sides of each adjacent pair of the teeth is substantially equal to the apex angle.

3. The fiber reinforced plastic propeller shaft according to claim 1, wherein a ratio of the height of each tooth to the width of the proximal end of each tooth is between 0.63 and 1.16, and wherein the width of the distal end of each tooth is 0.05±0.02 mm.

4. The fiber reinforced plastic propeller shaft according to claim 1, wherein the width of the distal end of each tooth is equal to or less than 0.1 mm.

5. The fiber reinforced plastic propeller shaft according to claim 1, wherein a section of each tooth that corresponds to one fifth of the height of the tooth digs into the inner surface of the pipe end.

6. The fiber reinforced plastic propeller shaft according to claim 1, wherein the outer diameter of the serration is between 70 mm and 75 mm, and wherein the number of the teeth is between 142 and 145.

7. The fiber reinforced plastic propeller shaft according to claim 1, wherein the metal member is a yoke.

8. The fiber reinforced plastic propeller shaft according to claim 1, wherein the apex angle of each tooth is between 50° and 70°.

9. The fiber reinforced plastic propeller shaft according to claim 1, wherein the apex angle of each tooth is between 55° and 65°.

10. The fiber reinforced plastic propeller shaft according to claim 1, wherein the width of the distal end of each tooth is 0.05±0.02 mm.

11. The fiber reinforced plastic propeller shaft according to claim 1, wherein the distal ends of each adjacent pair of the teeth are separated by a predetermined distance.

12. The fiber reinforced plastic propeller shaft according to claim 11, wherein the sides of each tooth are curved in the vicinity of the proximal end.

13. The fiber reinforced plastic propeller shaft according to claim 1, wherein a connecting angle defined by facing sides of each adjacent pair of the teeth is different from the apex angle.

14. The fiber reinforced plastic propeller shaft according to claim 1, wherein the distance between an imaginary circle containing the distal ends of the teeth and an intersection of straight lines each containing the side of one of any adjacent teeth is 0.9 to 1.8 mm.

15. The fiber reinforced plastic propeller shaft according to claim 1, wherein the height of each tooth is 0.9 to 1.8 mm.

16. The fiber reinforced plastic propeller shaft according to claim 1, wherein the facing sides of any adjacent teeth are connected through a curved plane.

17. The fiber reinforced plastic propeller shaft according to claim 1, wherein the metal member includes an engaging portion attached to an end of the pipe and a joint portion welded to the engaging portion.

18. A method for manufacturing a fiber reinforced plastic propeller shaft comprising:
preparing a fiber reinforced plastic pipe; and
attaching a metal member to an end of the pipe, wherein the metal member is provided with a serration having a plurality of teeth, wherein, when the metal member is attached to the end of the pipe, each tooth forms on the inner surface of the pipe end a groove extending along the axial direction of the pipe, and wherein the apex angle of each tooth is between 45° and 75°.

19. The method for manufacturing a fiber reinforced plastic propeller shaft according to claim 18, wherein the metal member includes an engaging portion and a joint portion, which are separately prepared in advance, and wherein step of attaching the metal member to the end of the pipe includes:
press fitting the engaging portion into the pipe; and
welding the joint portion to the engaging portion.
